(19) United States
(12) Patent Application Publication
(10) Pub. No.: US 2026/0003225 A1
(43) Pub. Date: Jan. 1, 2026

(54) DISPLAY APPARATUS

(71) Applicant: AUO Corporation, Hsinchu City (TW)

(72) Inventors: Min-Hsuan Chiu, Hsinchu City (TW); Wei-Ming Cheng, Hsinchu City (TW)

(73) Assignee: AUO Corporation, Hsinchu City (TW)

(21) Appl. No.: 18/985,052

(22) Filed: Dec. 18, 2024

(30) Foreign Application Priority Data
Jun. 27, 2024 (TW) 113124090

(51) Int. Cl. G02F 1/1335; G02F 1/1337; G02F 1/1343

(52) U.S. Cl. CPC G02F 1/133528; G02F 1/133784; G02F 1/134309

(57) ABSTRACT

A display apparatus includes a display panel, a switching panel, a first polarizer and a second polarizer. The switching panel includes a first substrate, a second substrate, a liquid crystal layer, a first electrode and a second electrode. At least one of the first electrode and the second electrode is disposed on the first substrate. The display panel, the first polarizer, the switching panel and the second polarizer are stacked sequentially in a vertical direction. An absorption axis of the first polarizer is substantially perpendicular to the vertical direction. An absorption axis of the second polarizer is substantially parallel to the vertical direction.

### CROSS-REFERENCE TO RELATED APPLICATION

This application claims the priority benefit of Taiwan application serial no. 113124090, filed on Jun. 27, 2024. The entirety of the above-mentioned patent application is hereby incorporated by reference herein and made a part of this specification.

### BACKGROUND

### Technical Field

The disclosure relates to an optoelectronic apparatus, and in particular relates to a display apparatus.

### Description of Related Art

Modern display apparatuses, owing to their advantages of being lightweight, thin, compact, and energy-efficient, have been widely applied in various electronic products, such as televisions, desktop PCs, smartphones, notebooks, and tablet PCs. With the development of display technology and the emphasis of the public on privacy, anti-peep technology of display apparatuses has garnered more attention. Consequently, researchers have been dedicating substantial efforts to the development of anti-peep technology. Generally speaking, conventional anti-peep display apparatuses mostly use a collimated backlight module and a switching panel to achieve switching between a privacy mode and a share mode. However, when the conventional anti-peep display apparatus is switched to the share mode, there is a significant discrepancy between the brightness at large vertical viewing angles and the brightness at the front viewing angle, which adversely affects the display performance.

### SUMMARY

A display apparatus with good performance is provided in the disclosure.

The display apparatus of the disclosure includes a display panel, a switching panel, a first polarizer, and a second polarizer. The switching panel is disposed on the display panel. The switching panel includes a first substrate, a second substrate, a liquid crystal layer, a first electrode, and a second electrode. The second substrate is disposed opposite to the first substrate. The liquid crystal layer is disposed between the first substrate and the second substrate. At least one of the first electrode and the second electrode is disposed on the first substrate. The display panel, the first polarizer, the switching panel, and the second polarizer are stacked sequentially in a vertical direction. An absorption axis of the first polarizer is substantially perpendicular to the vertical direction. An absorption axis of the second polarizer is substantially parallel to the vertical direction.

### BRIEF DESCRIPTION OF THE DRAWINGS

FIG. 1 is a three-dimensional and exploded schematic diagram of a display apparatus of an embodiment of the disclosure.

FIG. 2 is a cross-sectional schematic diagram of a switching panel of a display apparatus of an embodiment of the disclosure.

FIG. 3 is a top schematic diagram of a rubbing direction of a first substrate, a first electrode, a second electrode, and an alignment layer of the switching panel and an absorption axis of the first polarizer of an embodiment of the disclosure.

FIG. 4 is a luminance distribution schematic diagram at each azimuth angle φ and each inclination angle θ of the display apparatus in privacy mode of an embodiment of the disclosure.

FIG. 5 is a luminance distribution schematic diagram at each azimuth angle φ and each inclination angle θ of the display apparatus in share mode of an embodiment of the disclosure.

FIG. 6 is a three-dimensional and exploded schematic diagram of a display apparatus of the first comparative example.

FIG. 7 is a three-dimensional and exploded schematic diagram of a display apparatus of the second comparative example.

FIG. 8 is a three-dimensional and exploded schematic diagram of a display apparatus of another embodiment of the disclosure.

FIG. 9 is a cross-sectional schematic diagram of a switching panel of a display apparatus of another embodiment of the disclosure.

FIG. 10 is a top schematic diagram of a rubbing direction of a first substrate, a first electrode, a second electrode, and an alignment layer of the switching panel and an absorption axis of the first polarizer of another embodiment of the disclosure.

FIG. 11 is a three-dimensional and exploded schematic diagram of a display apparatus of yet another embodiment of the disclosure.

FIG. 12 is a cross-sectional schematic diagram of a switching panel of a display apparatus of yet another embodiment of the disclosure.

FIG. 13 is a top schematic diagram of a rubbing direction of a first substrate, a second substrate, a first electrode, a second electrode, and an alignment layer of the switching panel and an absorption axis of the first polarizer of yet another embodiment of the disclosure.

FIG. 14 is a luminance distribution schematic diagram at each azimuth angle φ and each inclination angle θ of the display apparatus in privacy mode of another embodiment of the disclosure.

FIG. 15 is a luminance distribution schematic diagram at each azimuth angle φ and each inclination angle θ of the display apparatus in share mode of another embodiment of the disclosure.

FIG. 16 is a three-dimensional and exploded schematic diagram of a display apparatus of yet another embodiment of the disclosure.

FIG. 17 is a luminance distribution schematic diagram at each azimuth angle φ and each inclination angle θ of the display apparatus in privacy mode of yet another embodiment of the disclosure.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

It should be understood that when an element such as a layer, a film, an area, or a substrate is indicated to be “on” another element or “connected to” another element, it may be directly on another element or connected to another element, or an element in the middle may exist. In contrast, when an element is indicated to be “directly on another element” or “directly connected to” another element, an element in the middle does not exist. As used herein, “to connect” may indicate to physically and/or electrically connect. Furthermore, “to electrically connect” or “to couple” may also be used when other elements exist between two elements.

The usages of “approximately”, “similar to”, or “substantially” indicated throughout the specification include the indicated value and an average value having an acceptable deviation range, which is a certain value confirmed by people skilled in the art, and is a certain amount considered the discussed measurement and measurement-related deviation (i.e., the limitation of measurement system). For example, “approximately” may indicate to be within one or more standard deviations of the indicated value, or being within ±30%, ±20%, ±10%, ±5%. Furthermore, the usages of “approximately”, “similar to”, or “substantially” indicated throughout the specification may refer to a more acceptable deviation scope or standard deviation depending on optical properties, etching properties, or other properties, and all properties may not be applied with one standard deviation.

Unless otherwise defined, all terms (including technical and scientific terms) used herein have the same meaning as that commonly understood by one of ordinary skill in the art to which this disclosure belongs. It should be further understood that terms such as those defined in commonly used dictionaries should be construed as having meanings consistent with their meanings in the context of the related art and the disclosure, and are not to be construed as idealized or excessive formal meaning, unless expressly defined as such herein.

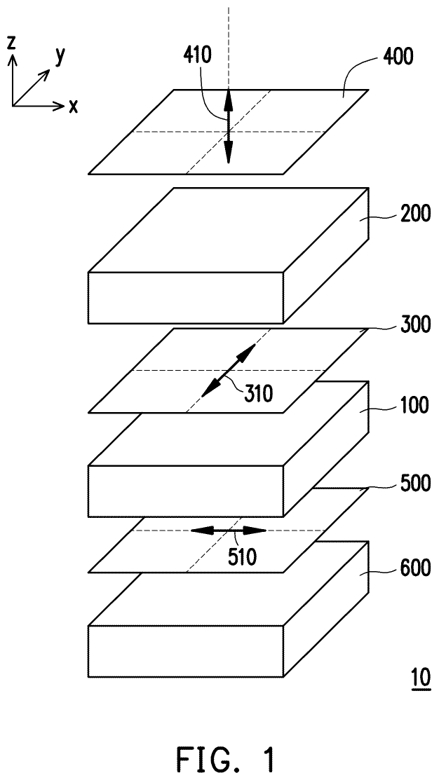

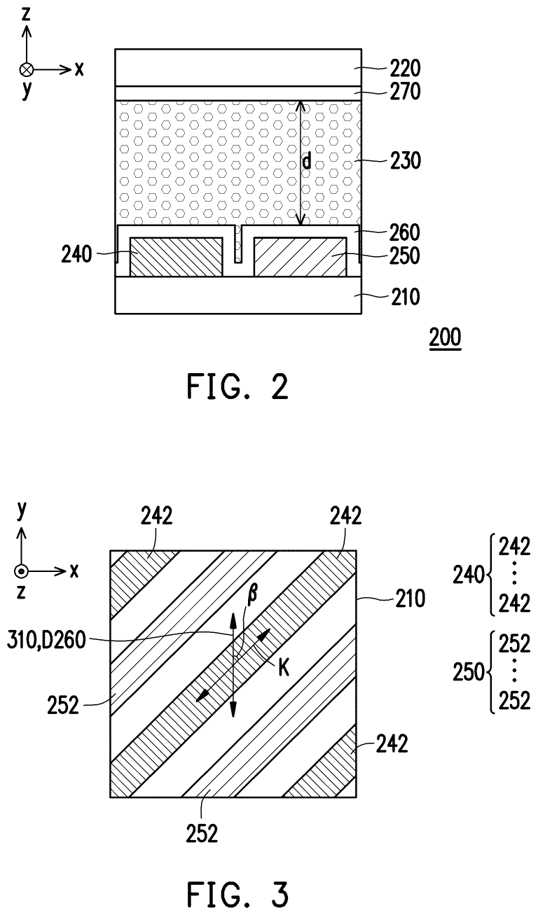

FIG. 1 is a three-dimensional and exploded schematic diagram of a display apparatus of an embodiment of the disclosure. FIG. 2 is a cross-sectional schematic diagram of a switching panel of a display apparatus of an embodiment of the disclosure. FIG. 3 is a top schematic diagram of a rubbing direction of a first substrate, a first electrode, a second electrode, and an alignment layer of the switching panel and an absorption axis of the first polarizer of an embodiment of the disclosure. For clear expression, the first direction x, the second direction y, and the vertical direction z that are perpendicular to each other are drawn in each figure.

Referring to FIG. 1, the display apparatus 10 includes a display panel 100, a switching panel 200, a first polarizer 300, and a second polarizer 400. The switching panel 200 is disposed on the display panel 100. The display panel 100, the first polarizer 300, the switching panel 200, and the second polarizer 400 are stacked sequentially in the vertical direction z.

In some embodiments, the display panel 100 is, for example, a liquid crystal display panel, in which the liquid crystal display panel may include a pixel array substrate (not shown), a counter substrate (not shown) disposed opposite to the pixel array substrate, and a liquid crystal layer (not shown) located between the pixel array substrate and the counter substrate.

In some embodiments, when the display panel 100 is a liquid crystal display panel, the display apparatus 10 may further include a third polarizer 500 and a backlight 600, in which the backlight 600, the third polarizer 500, the display panel 100, the first polarizer 300, the switching panel 200, and the second polarizer 400 are stacked sequentially in the vertical direction z. In some embodiments, the backlight 600 is not a collimated backlight module. For example, in some embodiments, the backlight 600 may include a light guide plate (not shown), a first brightness enhancement film (not shown), a second brightness enhancement film (not shown), and a diffusion sheet (not shown). The first brightness enhancement film, the second brightness enhancement film, and the diffusion sheet are stacked sequentially on the light guide plate, and the extension direction of multiple prism pillars of the first brightness enhancement film is substantially perpendicular to the extension direction of multiple prism pillars of the second brightness enhancement film, but the disclosure is not limited thereto.

In addition, it should be noted that the disclosure does not limit the display panel 100 to be a liquid crystal display panel. In other embodiments, the display panel 100 may also be other types of display panels, such as an organic electroluminescent display panel, a micro light-emitting diode display panel, and other self-luminous display panels. When the display panel 100 is a self-luminous display panel, the display apparatus 10 may omit the third polarizer 500 and the backlight 600.

Referring to FIG. 1 and FIG. 2, the switching panel 200 includes a first substrate 210, a second substrate 220, a liquid crystal layer 230, a first electrode 240, and a second electrode 250. The second substrate 220 is disposed opposite to the first substrate 210. The liquid crystal layer 230 is disposed between the first substrate 210 and the second substrate 220. At least one of the first electrode 240 and the second electrode 250 is disposed on the first substrate 210. For example, in some embodiments, both the first electrode 240 and the second electrode 250 may be selectively disposed on the first substrate 210, and the first electrode 240 and the second electrode 250 are located on the same side of the liquid crystal layer 230, but the disclosure is not limited thereto.

Referring to FIG. 1, FIG. 2 and FIG. 3, in some embodiments, at least one of the first electrode 240 and the second electrode 250 has multiple branches 242, 252. The branches 242, 252 are spaced apart from each other and extend in the branch direction K, the branch direction K forms an angle β with the absorption axis 310 of the first polarizer 300, and 0°<β<90°. In some embodiments, preferably, 35°<β<55°. For example, in some embodiments, β=45°, but the disclosure is not limited thereto.

In some embodiments, the first electrode 240 and the second electrode 250 of the switching panel 200 may selectively have multiple branches 242 and multiple branches 252 respectively, the branches 242 and the branches 252 are substantially located on the same plane and are arranged alternately. That is, in some embodiments, the switching panel 200 may be an in-plane switching (IPS) type. However, the disclosure is not limited thereto, and in other embodiments, the switching panel 200 may also be of other types, which are illustrated in the following paragraphs with other drawings.

Referring to FIG. 1 and FIG. 2, in some embodiments, the switching panel 200 further includes an alignment layer 260, in which the alignment layer 260 is disposed between the liquid crystal layer 230 and the first electrode 240. In some embodiments, the switching panel 200 further includes an alignment layer 270, in which the alignment layer 270 is disposed between the second substrate 220 and the liquid crystal layer 230.

The first substrate 210 and the second substrate 220 are light-transmissive substrates. In some embodiments, the light-transmissive substrate may be glass, quartz, organic polymer, or other suitable materials, but the disclosure is not limited thereto. In some embodiments, the first electrode 240 and the second electrode 250 are light-transmissive electrodes. In some embodiments, the material of the light-transmissive electrode may be a metal oxide, such as indium tin oxide, indium zinc oxide, aluminum tin oxide, aluminum zinc oxide, indium germanium zinc oxide, other suitable oxides, or a stacked layer of at least two of the above, but the disclosure is not limited thereto.

Referring to FIG. 1, the absorption axis 310 of the first polarizer 300 is substantially perpendicular to the vertical direction z. The first polarizer 300 is located on the plane defined by the first direction x and the second direction y, and the absorption axis 310 of the first polarizer 300 is substantially parallel to the second direction y. The absorption axis 410 of the second polarizer 400 is substantially parallel to the vertical direction z. The absorption axis 410 of the second polarizer 400 is located in the thickness direction of the second polarizer 400. In some embodiments, the display apparatus 10 includes a third polarizer 500, and the absorption axis 510 of the third polarizer 500 is substantially parallel to the first direction x.

Referring to FIG. 1, FIG. 2, and FIG. 3, in some embodiments, the alignment layer 260 of the switching panel 200 has a rubbing direction D260, and the rubbing direction D260 is substantially parallel or perpendicular to the absorption axis 310 of the first polarizer 300.

Referring to FIG. 1 and FIG. 2, the liquid crystal layer 230 of the switching panel 200 has a phase retardation value Δn·d, in which Δn is the birefringence of the liquid crystal layer 230 and d is the thickness of the liquid crystal layer 230. In some embodiments, the phase retardation value Δn·d may fall in the range of 120 nm to 450 nm. For example, in some embodiments, Δn·d may fall in the range of 300 nm to 400 nm, and the enabled switching panel 200 is equivalent to a three-quarter wave plate (or a negative quarter wave plate), but the disclosure is not limited thereto.

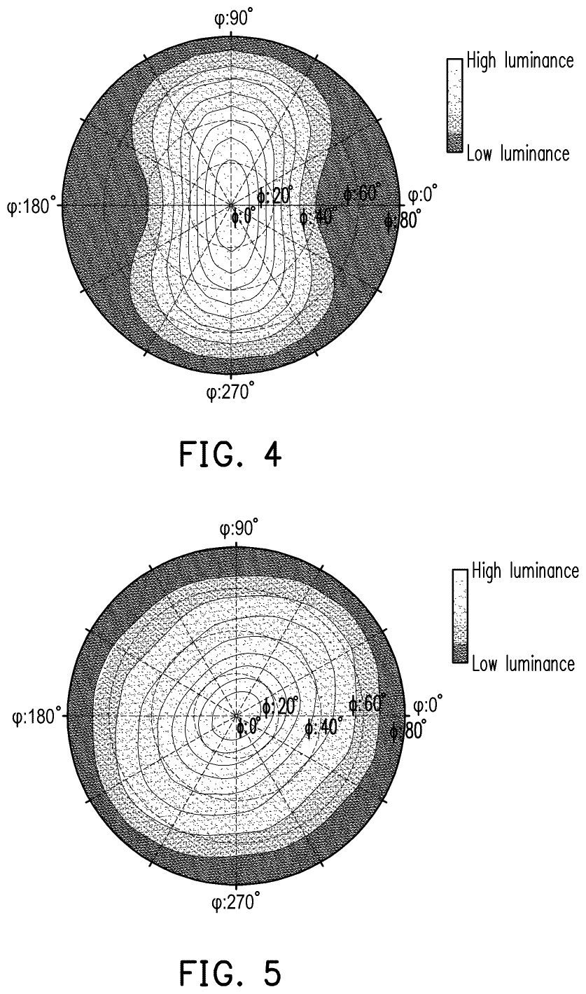

FIG. 4 is a luminance distribution schematic diagram at each azimuth angle φ and each inclination angle θ of the display apparatus in privacy mode of an embodiment of the disclosure. Referring to FIG. 1, FIG. 2 and FIG. 4, when the potential difference between the first electrode 240 and the second electrode 250 of the switching panel 200 is substantially zero (i.e., when the switching panel 200 is not enabled), the display apparatus 10 is in privacy mode. Specifically, in some embodiments, the light beam (not shown) from the display panel 100 has a linear polarization state in the first direction x after passing through the first polarizer 300. After the light beam with the linear polarization state in the first direction x passes through the unenabled switching panel 200, the polarization state of the light beam does not change and still has the linear polarization state in the first direction x. When the light beam from the unenabled switching panel 200 and having a linear polarization state in the first direction x passes through the second polarizer 400 whose absorption axis 410 is parallel to the vertical direction z, in the first axis direction where the azimuth angle φ=0° and the azimuth angle φ=180° are located, if the light beam with the linear polarization state in the first direction x is incident on the second polarizer 400 at a larger angle, the greater amount of the light beam will be absorbed. Through this, the anti-peep effect in the first axis direction (i.e., the left and right viewing angles) may be achieved.

FIG. 5 is a luminance distribution schematic diagram at each azimuth angle φ and each inclination angle θ of the display apparatus in share mode of an embodiment of the disclosure. Referring to FIG. 1, FIG. 2, and FIG. 5, the first electrode 240 and the second electrode 250 of the switching panel 200 have a potential difference (i.e., when the switching panel 200 is enabled), the display apparatus 10 is in share mode. Specifically, in some embodiments, the light beam (not shown) from the display panel 100 has a linear polarization state in the first direction x after passing through the first polarizer 300. After the light beam with the linear polarization state in the first direction x passes through the enabled switching panel 200 (equivalent to a three-quarter wave plate), the polarization state of the light beam changes to a circular polarization state or a quasi-circular polarization state. When the light beam from the enabled switching panel 200 and having a circular polarization state or a quasi-circular polarization state passes through the second polarizer 400 whose absorption axis 410 is parallel to the vertical direction z, at each azimuth angle, the proportion of light beams with circular polarization or quasi-circular polarization that may pass through the second polarizer 400 is the same or similar. Through this, the sharing effect may be achieved from various viewing angles.

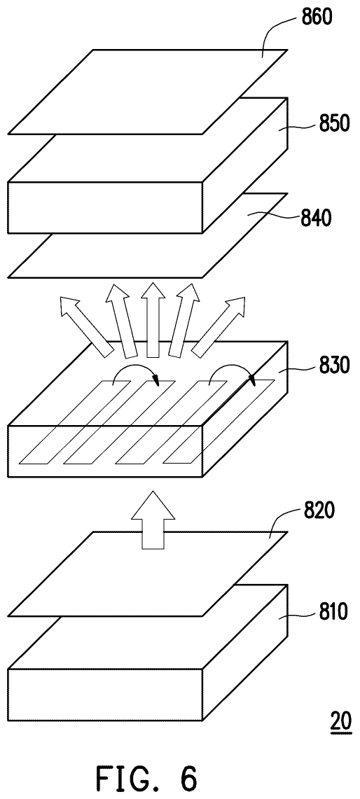

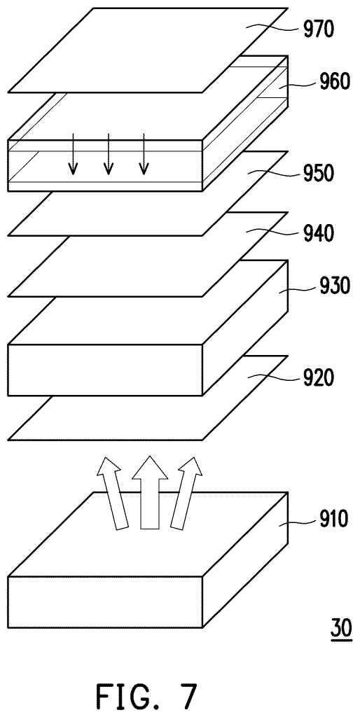

It is worth mentioning that the display apparatus 10, which may switch between a privacy mode and a share mode by utilizing the second polarizer 400 with an absorption axis 410 parallel to the vertical direction z in conjunction with the switching panel 200, ensures that the brightness difference between the large vertical viewing angles (i.e., at the large inclination angle θ at the azimuth angle φ=90° and the azimuth angle) φ=270° and the front viewing angle (i.e., at the azimuth angle φ=0° and the inclination angle) θ=0° in the share mode is minimized, thereby improving the display effect of the display apparatus 10 in the share mode. The following is an example for illustration with reference to FIG. 6, FIG. 7, and Table 1.

FIG. 6 is a three-dimensional and exploded schematic diagram of a display apparatus of the first comparative example. The display apparatus 20 of the first comparative example in FIG. 6 includes a collimated backlight 810, an anti-peep film 820, a switching panel 830, a polarizer 840, a display panel 850, and a polarizer 860. The anti-peep film 820, the switching panel 830, the polarizer 840, the display panel 850, and the polarizer 860 are stacked sequentially on the collimated backlight 810. The display apparatus 20 of the first comparative example adopts a scattering anti-peep technology.

FIG. 7 is a three-dimensional and exploded schematic diagram of a display apparatus of the second comparative example. The display apparatus 30 of the second comparative example in FIG. 7 includes a collimated backlight 910, a polarizer 920, a display panel 930, a polarizer 940, a compensation film 950, a switching panel 960, and a polarizer 970. The polarizer 920, the display panel 930, the polarizer 940, the compensation film 950, the switching panel 960, and the polarizer 970 are stacked sequentially on the collimated backlight 910. The display apparatus 30 of the second comparative example adopts a phase retardation anti-peep technology.

Table 1 below lists the ratios of the brightness of the display apparatus 10 of an embodiment of the disclosure, the display apparatus 20 of the first comparative example, and the display apparatus 30 of the second comparative example at various azimuth angles φ and inclination angles θ relative to the brightness at the front viewing angle (i.e., at the azimuth angle φ=0° and the inclination angle) θ=0°. The data in Table 1 below indicates that in the share mode, compared with the display apparatus 20 of the first comparative example and the display apparatus 30 of the second comparative example, the display apparatus 10 of an embodiment of the disclosure has a small difference in brightness between a large upper viewing angle (i.e., at the azimuth angle φ=90° and a large inclination angle θ) and the front viewing angle (i.e., at the azimuth angle φ=0° and the inclination angle) θ=0°. For example, in the share mode, at a large upper viewing angle (i.e., at the azimuth angle φ=90° and the inclination angle) θ=45°, the ratio of the brightness at the large upper viewing angle to the brightness at the front viewing angle of the display apparatus 20 of the first comparative example is 1.41%, the ratio of the brightness at the large upper viewing angle to the brightness at the front viewing angle of the display apparatus 30 of the second comparative example is 1.8%, and the ratio of the brightness at the large upper 10 viewing angle to the brightness at the front viewing angle of the display apparatus 10 of an embodiment of the disclosure is increased to 4.69%. That is, the difference in brightness between the large upper viewing angle and the front viewing angle of the display apparatus 10 of an embodiment of the disclosure is small.

TABLE 1

| | | | | | Display | Display |
|---|---|---|---|---|---|---|
| | | | | | apparatus 20 | apparatus 30 |
| | | | | | of the first | of the second |
| | | | | | comparative | comparative |
| | Display apparatus 10 of the embodiment | | | | example | example |
| | Privacy mode | | Share mode | | | |
| | Azimuth | Azimuth | Azimuth | Azimuth | Azimuth | Azimuth |
| | angle | angle | angle | angle | angle | angle |
| | φ = 90° | φ = 0° | φ = 90° | φ = 0° | φ = 90° | φ = 0° |
| Inclination angle | 8.75% | 0.90% | 5.26% | 5.60% | 1.61% | 2.1% |
| θ = −45° | | | | | | |
| Inclination angle | 24.47% | 8.30% | 16.67% | 17.36% | 4.26% | 5.22% |
| θ = −30° | | | | | | |
| Inclination angle | 54.31% | 50.69% | 47.35% | 59.64% | | |
| θ = −15° | | | | | | |
| Inclination angle | | | | | | |
| θ = 0° | | | | | | |
| Inclination angle | 49.15% | 61.88% | 42.85% | 72.71% | | |
| θ = 15° | | | | | | |
| Inclination angle | 19.29% | 10.71% | 13.21% | 22.31% | 2.69% | 3.61% |
| θ = 30° | | | | | | |
| Inclination angle | 7.73% | 1.07% | 4.69% | 6.62% | 1.41% | 1.8% |
| θ = 45° | | | | | | |

It is to be noted that the following embodiments use the reference numerals and a part of the contents of the above embodiments, and the same reference numerals are used to denote the same or similar elements, and the description of the same technical contents is omitted. For the description of the omitted part, reference may be made to the above embodiments, and details are not described in the following embodiments.

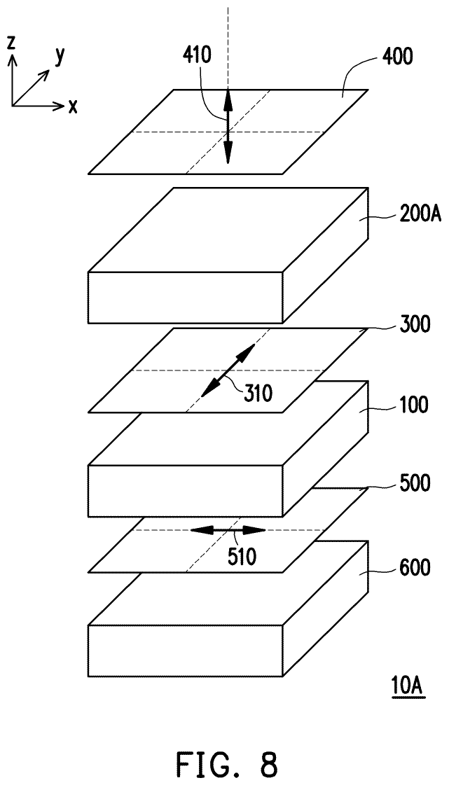

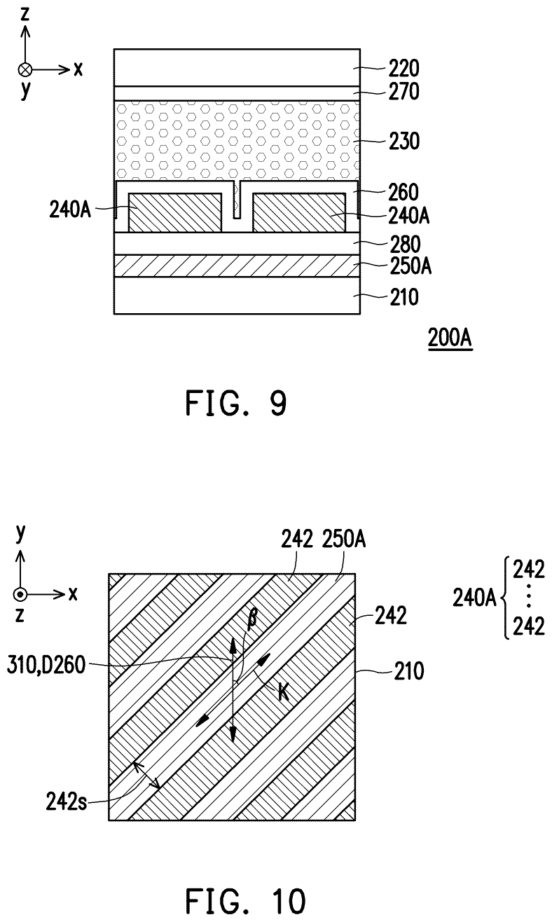

FIG. 8 is a three-dimensional and exploded schematic diagram of a display apparatus of another embodiment of the disclosure. FIG. 9 is a cross-sectional schematic diagram of a switching panel of a display apparatus of another embodiment of the disclosure. FIG. 10 is a top schematic diagram of a rubbing direction of a first substrate, a first electrode, a second electrode, and an alignment layer of the switching panel and an absorption axis of the first polarizer of another embodiment of the disclosure. For clear expression, the first direction x, the second direction y, and the vertical direction z that are perpendicular to each other are drawn in each figure.

The display apparatus 10A of the embodiments shown in FIG. 8, FIG. 9, and FIG. 10 is similar to the display apparatus 10 of the embodiments shown in FIG. 1, FIG. 2, and FIG. 3. The difference between the two is that the switching panels 200 and 200A are different. Referring to FIG. 8, FIG. 9 and FIG. 10, specifically, in this embodiment, an insulation layer 280 is disposed between the first electrode 240A and the second electrode 250A of the switching panel 200A. The first electrode 240A disposed on the insulation layer 280 has multiple branches 242, and the second electrode 250A overlaps the slits 242s between the plurality of branches 242. In short, in this embodiment, the switching panel 200A is a fringe field switching (FFS) type panel.

The display apparatus 10A of this embodiment has similar functions and advantages to the display apparatus 10 of the previous embodiment, which are not repeated herein.

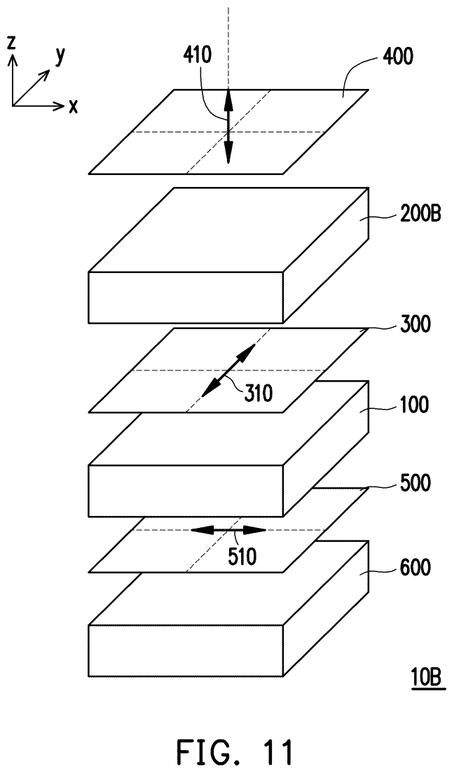

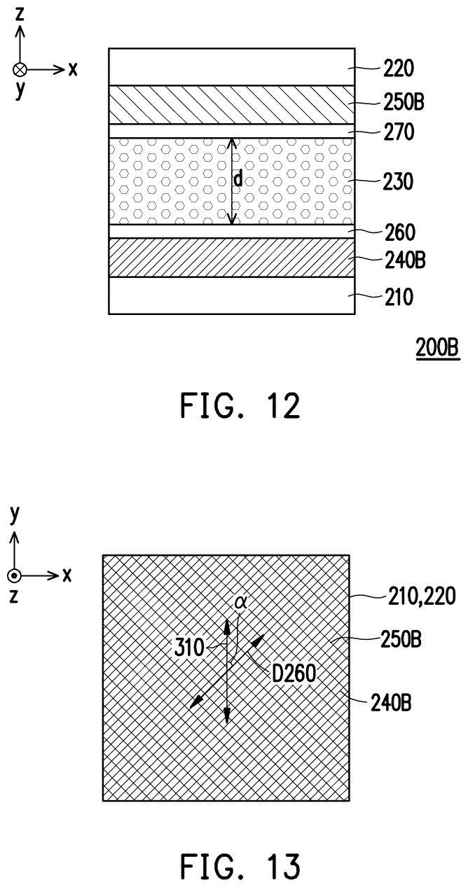

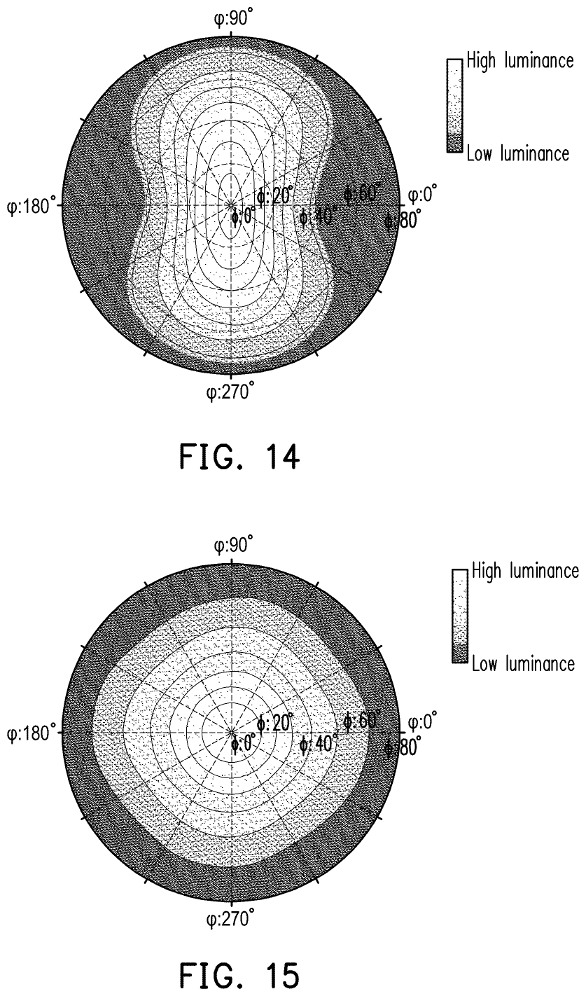

FIG. 11 is a three-dimensional and exploded schematic diagram of a display apparatus of yet another embodiment of the disclosure. FIG. 12 is a cross-sectional schematic diagram of a switching panel of a display apparatus of yet another embodiment of the disclosure. FIG. 13 is a top schematic diagram of a rubbing direction of a first substrate, a second substrate, a first electrode, a second electrode, and an alignment layer of the switching panel and an absorption axis of the first polarizer of yet another embodiment of the disclosure. For clear expression, the first direction x, the second direction y, and the vertical direction z that are perpendicular to each other are drawn in each figure. FIG. 14 is a luminance distribution schematic diagram at each azimuth angle φ and each inclination angle θ of the display apparatus in privacy mode of another embodiment of the disclosure. FIG. 15 is a luminance distribution schematic diagram at each azimuth angle φ and each inclination angle θ of the display apparatus in share mode of another embodiment of the disclosure.

The display apparatus 10B of the embodiments shown in FIG. 11, FIG. 12, and FIG. 13 is similar to the display apparatus 10 of the embodiments shown in FIG. 1, FIG. 2, and FIG. 3. The difference between the two is that the switching panels 200 and 200B are different.

Referring to FIG. 11, FIG. 12, and FIG. 13, specifically, in this embodiment, the first electrode 240B and the second electrode 250B of the switching panel 200B may be selectively disposed on the first substrate 210 and the second substrate 220 respectively. The first electrode 240B and the second electrode 250B are respectively located on both sides of the liquid crystal layer 230, but the disclosure is not limited thereto.

In this embodiment, the alignment layer 260 of the switching panel 200B has a rubbing direction D260, and the rubbing direction D260 has an angle α with the absorption axis 310 of the first polarizer 300, and 0°<α<90°. In some embodiments, preferably, 35°<α<55°. For example, in some embodiments, α=45°, but the disclosure is not limited thereto.

The liquid crystal layer 230 of the switching panel 200B has a phase retardation value Δn·d, in which Δn is the birefringence of the liquid crystal layer 230 and d is the thickness of the liquid crystal layer 230. For example, in this embodiment, Δn·d=140 nm, and the enabled switching panel 200B is equivalent to a quarter wave plate, but the disclosure is not limited thereto.

The display apparatus 10B of this embodiment has similar functions and advantages to the display apparatus 10 of the previous embodiment, which are not repeated herein.

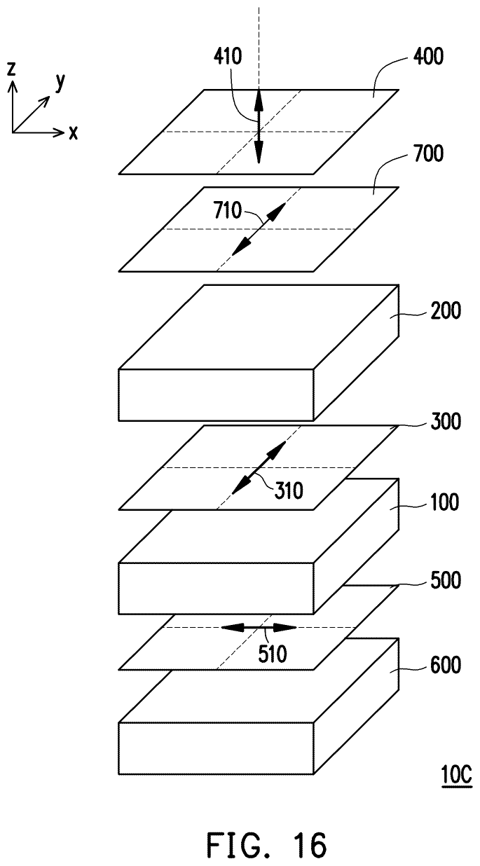

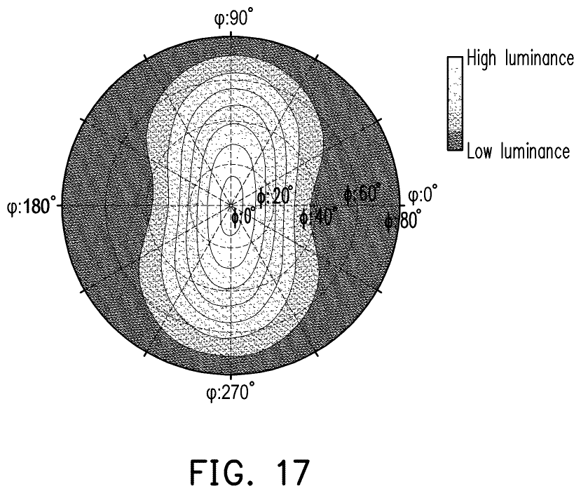

FIG. 16 is a three-dimensional and exploded schematic diagram of a display apparatus of yet another embodiment of the disclosure. FIG. 17 is a luminance distribution schematic diagram at each azimuth angle φ and each inclination angle θ of the display apparatus in privacy mode of yet another embodiment of the disclosure.

The display apparatus 10C of the embodiment of FIG. 16 is similar to the display apparatus 10 of the embodiment of FIG. 1. The difference between the two is that the display apparatus 10C of FIG. 16 further includes a compensation film 700. Referring to FIG. 16, the compensation film 700 is a biaxial film. The compensation film 700 is disposed between the second polarizer 400 and the switching panel 200, and the slow axis 710 of the compensation film 700 is substantially parallel or perpendicular to the absorption axis 310 of the first polarizer 300. For example, in some embodiments, the in-plane phase difference of the compensation film 700 is R_{O}, the thickness direction phase difference of the compensation film 700 is Rₜₕ, 190 nm≤R_{O}≤350 nm, and −20nm≤Rₜₕ≤20 nm, but the disclosure is not limited thereto.

FIG. 17 corresponds to the display apparatus 10C of FIG. 16 including the compensation film 700. FIG. 4 corresponds to the display apparatus 10 of FIG. 1 without the compensation film 700. Comparing FIG. 17 with FIG. 4, it may be seen that the addition of the compensation film 700 may significantly improve the light leakage in the non-axial direction (i.e., the azimuth angle φ is not 0°, 90°, 180°, and 270°) of the display apparatus 10C in the privacy mode.

Taking the azimuth angle φ=45° and the inclination angle θ=45° as an example, the ratio of the brightness at the azimuth angle φ=45° and the inclination angle θ=45° to the brightness at the front viewing angle of the display apparatus 10 without the compensation film 700 is 35.7%. The ratio of the brightness at the azimuth angle φ=45° and the inclination angle θ=45° to the front viewing angle of the display apparatus 10C including the compensation film 700 is significantly reduced to 23.4%. In other words, the addition of the compensation film 700 may effectively improve the anti-peep capability of the display apparatus 10C in the non-axial direction.

What is claimed is:

1. A display apparatus, comprising:
a display panel; and
a switching panel, disposed on the display panel, wherein the switching panel comprises:
a first substrate;
a second substrate, disposed opposite to the first substrate;
a liquid crystal layer, disposed between the first substrate and the second substrate;
a first electrode and a second electrode, wherein at least one of the first electrode and the second electrode is disposed on the first substrate;
a first polarizer and a second polarizer, wherein the display panel, the first polarizer, the switching panel, and the second polarizer are stacked sequentially in a vertical direction;
wherein an absorption axis of the first polarizer is substantially perpendicular to the vertical direction, and an absorption axis of the second polarizer is substantially parallel to the vertical direction.

2. The display apparatus according to claim 1, wherein the first electrode and the second electrode are respectively disposed on the first substrate and the second substrate, the switching panel further comprises:
an alignment layer, disposed between the liquid crystal layer and the first electrode, wherein the alignment layer has a rubbing direction, and the rubbing direction has an angle with the absorption axis of the first polarizer, the angle is α, and 0°<α<90°.

3. The display apparatus according to claim 2, wherein 35°<α<55°.

4. The display apparatus according to claim 1, wherein the first electrode and the second electrode are disposed on the first substrate, and the switching panel further comprises:
an alignment layer, disposed between the first electrode and the liquid crystal layer, wherein the alignment layer has a rubbing direction, and the rubbing direction is substantially parallel or perpendicular to the absorption axis of the first polarizer.

5. The display apparatus according to claim 4, wherein the at least one of the first electrode and the second electrode has a plurality of branches, the branches are spaced apart from each other and extend in a branch direction, and the branch direction forms an angle with the absorption axis of the first polarizer, the angle is β, and 0°<β<90°.

6. The display apparatus according to claim 5, wherein 35°<β<55°.

7. The display apparatus according to claim 1, wherein the liquid crystal layer has a phase retardation value, and the phase retardation value falls in a range of 120 nm to 450 nm.

8. The display apparatus according to claim 1, further comprising:
a biaxial film, disposed between the second polarizer and the switching panel, wherein a slow axis of the biaxial film is substantially parallel or perpendicular to the absorption axis of the first polarizer.

9. The display apparatus according to claim 8, wherein an in-plane phase difference of the biaxial film is R_{O}, and 190 nm≤R_{O}≤350 nm.

10. The display apparatus according to claim 8, wherein a thickness direction phase difference of the biaxial film is Rₜₕ, and −20 nm≤Rₜₕ≤20 nm.

11. The display apparatus according to claim 1, wherein a potential difference between the first electrode and the second electrode is substantially zero, and the display apparatus is in a privacy mode.

12. The display apparatus according to claim 1, wherein the first electrode and the second electrode have a potential difference, and the display apparatus is in a share mode.
